(19) United States
(12) Patent Application Publication
(10) Pub. No.: US 2025/0058588 A1
(43) Pub. Date: Feb. 20, 2025

(54) CAR TYRE

(71) Applicant: Pirelli Tyre S.p.A., Milano (IT)

(72) Inventors: Giulio Lorenzo DUPRE', Milano (IT); Diego Ettore SPEZIARI, Milano (IT); Damiano Leonardo BELLUZZO, Milano (IT)

(73) Assignee: Pirelli Tyre S.p.A., Milano (IT)

(21) Appl. No.: 18/720,145

(22) PCT Filed: Dec. 15, 2022
(86) PCT No.: PCT/IB2022/062287

§ 371 Date: Jun. 14, 2024

(30) Foreign Application Priority Data
Dec. 22, 2021 (IT) 102021000032132

(51) Int. Cl. B60C 11/03; B60C 11/12

(52) U.S. Cl. CPC B60C 11/0304; B60C 11/0302; B60C 11/0306; B60C 11/033; B60C 11/1236; B60C 2011/0372

(57) ABSTRACT

Car tyre (100) having a tread band (7) comprising a central region (L1) and two shoulder regions (L2, L3); the central region (L1) having a plurality of ribs (8, 9, 10), wherein a first rib (8) with a plurality of first transverse grooves (15) comprising a substantially straight first segment (15′), inclined relative to a direction parallel to said equatorial plane (X-X) so as to form an angle Θ smaller than or equal to 70°, a substantially straight counter-inclined second segment (15″) and a curved connecting segment (15″′) extending between said first segment (15′) and said second segment (15″); —the first rib (8) further comprising first straight sipes (21) located in the first rib (8) between said first transverse grooves (15) and extending over at least 60% of the width of said first rib (8); the first sipes (21) forming with said equatorial plane (X-X) an angle Θ′ preferably equal to the angle Θ of the first segment (15′) of the first transverse grooves (15).

### FIELD OF THE INVENTION

The present invention relates to a tyre for passenger cars, in particular an “all season” tyre for high performance or ultra high performance cars.

### PRIOR ART

The following documents describe some examples of high and ultra high performance car tyres: WO2009/004408, WO2015/008137, WO02/078982, WO2019/111089.

### SUMMARY OF THE INVENTION

“All season” tyres, which are increasingly appreciated and demanded by users, are generally required to have a very flexible behaviour, which should allow them to provide performance comparable to that of summer tyres in summer and of winter tyres in winter.

The Applicant noted that in order to have features comparable to those of the so-called winter tyres, “all season” tyres should be provided with treads characterised by a high number of grooves or recesses and by a greater depth thereof, as compared to those of a common summer tyre.

The Applicant further observed that, similarly to winter tyres, all season tyres can be characterised by the presence of a dense siping, which, particularly when the tyre rolls on snow-covered roads, provides the tyre with a greater grip on this type of ground, due to the capture of small amounts of snow inside the sipes and the increased friction produced by snow-on-snow contact.

However, the presence of a dense siping, together with the presence of wide and deep grooves, in circumferential and/or transvere direction reduces the rigidity of the tread band, with the consequent risk of performance decay at high speed on dry ground.

Moreover, the presence of grooves generates noise.

On the other hand, high or ultra high performance car tyres are required to provide performance, steering precision, and excellent grip, so that they can effectively transfer high torque to the ground and withstand high lateral stresses, even at the high operating temperatures associated with high-speed use.

Better results in terms of performance and grip could be achieved by significantly reducing the void-to-rubber of these tyres.

This kind of tyres, although excellent in terms of performance on track, could lower the safety parameters in wet and snowy conditions. In certain climatic conditions, the presence of precipitation, by making the road surface wet, would indeed significantly reduce tyre grip and would not ensure road holding, adequate traction, effective braking.

Furthermore, the Applicant has observed an increasing attention of users towards the ability of tyres, including UHP tyres, to provide long mileage.

The Applicant has indeed observed that, while until a short time ago the interest of users of this kind of tyres was almost exclusively oriented towards obtaining performance levels, nowadays the attention, keeping performance the same, is increasingly focused on mileage.

Generally, when aiming at achieving long tyre mileage, it is provided to have as much rubber to the ground as possible in the area where the tyre contacts the ground (footprint area), and to control the parameters that can affect the triggering of irregular wear phenomena. This is clearly in contrast with the need for “all season” tyres to have a high number of grooves, recesses and/or sipes.

In view of the above, it is clear that “all season” tyres for high or very high performance cars must meet several conflicting requirements in order to provide long mileage and good performance in each different road and weather condition.

The Applicant has therefore faced the problem of providing “all season” tyres for cars, in particular for high or ultra high performance cars, capable of ensuring long mileage, high performance levels in straight running and in cornering, braking and traction, and low noise, without at the same time reducing draining features, running safety on wet ground and mobility/running safety on snow-covered ground.

The Applicant has focused their efforts to achieve this improvement by producing a tyre provided with a tread band having a central region separated from two shoulder regions, respectively an outer shoulder region and an inner shoulder region. The central region of the tyre has been designed so as to have a substantially uniform and balanced distribution of grooves and sipes so as to obtain a void-to-rubber ratio which is substantially constant or slightly higher at the rib closest to the outer shoulder region.

This choice provides overall a good mix of rubber to the ground and grooves, which allows performance to be achieved without excessively compromising the safety features of the tyre on wet and/or snow-covered ground.

The distribution and extension of the transverse grooves together with the distribution of the sipes, in particular on the rib closest to the outer shoulder region, is such as to minimize the number of, or to avoid intersections with the remaining transverse grooves and/or sipes, so as not to locally weaken the tyre stiffness, which is thus maintained substantially constant throughout the central region.

In a first aspect thereof, the invention relates to a car tyre having a tread band comprising a central region, extending across an equatorial plane, and two shoulder regions, which are separated from the central region by a first circumferential groove, axially delimiting a first shoulder region from the central region, and a second circumferential groove, axially delimiting a second shoulder region from the central region;
said central region having a width greater than or equal to at least 35% of an effective width of said tread band;
said central region having a plurality of ribs comprising respective pluralities of transverse grooves and sipes; said plurality of ribs comprising at least one first rib comprising a plurality of first transverse grooves;
said first transverse grooves extending over at least 90% of the width of said first rib;
each first transverse groove comprising a substantially straight first segment, inclined relative to a direction parallel to said equatorial plane so as to form an angle θ smaller than or equal to 70°, a substantially straight second segment, counter-inclined relative to said first segment, and a curvilinear connecting segment extending between said first segment and said second segment;
said tread band further comprising a plurality of sipes comprising a plurality of first sipes located in said first rib between said first transverse grooves;
said first sipes extending over at least 60% of the width of said first rib;
said first sipes having a substantially straight course forming with said equatorial plane an angle θ′ concordant with said angle θ;
said first sipes having no mutual intersection points.

The Applicant has found that, thanks to these features, the tyre of the invention can achieve high performance levels as well as good mileage, while still being able to maintain safe driving on wet and/or snowy roads. Without wishing to be bound by any particular theory, the Applicant believes that the presence, on the ribs of the central region, of transverse grooves and sipes distributed homogeneously and having no, or in any case only a limited number of mutual intersectionsoptimizes the tread band stiffness distribution, both in circumferential direction and in lateral direction, so as to obtain high performance levels in terms of handling, traction, braking and mileage, without at the same time reducing draining features and safety on wet roads.

For the purposes of the present invention, the following definitions apply:

By “tread pattern” it is meant the representation of all points of the tread band (including recesses) in a plane perpendicular to the equatorial plane of the tyre and tangential to the maximum diameter of the tyre.

The measurements of angles and/or linear quantities (distances, widths, lengths, etc.) and/or surface areas are to be intended as referring to the tread pattern as defined above.

Furthermore, considering the angular arrangement of the grooves formed in the tread band relative to the equatorial plane of the tyre, such angular arrangement shall be understood, for each point of the groove, as referring to the acute angle (i.e., an angle comprised between 0° and 90° in absolute value) defined by a rotation starting from the equatorial plane to the direction tangent to the groove passing through that point.

By the term “equatorial plane” of the tyre it is meant a plane perpendicular to the rotation axis of the tyre and dividing the tyre into two substantially equal portions.

By “circumferential” direction it is meant a direction generally directed according to the rotation direction of the tyre, or slightly inclined (e.g., by at most about 15°) relative to the rotation direction of the tyre.

By “axial” direction it is meant a direction substantially parallel to the rotation axis of the tyre, or at most slightly inclined (e.g., by at most about 15°) relative to the rotation axis of the tyre. Generally, the axial direction is substantially perpendicular to the circumferential direction.

By the term “effective width” referred to the tread band it is meant the width of the radially outermost portion of the tread band (from one edge to the other) intended to contact the ground.

By the term “groove” it is meant a recess formed in a portion of the tread band, having a width greater than or equal to 2 mm and preferably a depth greater than 2 mm.

By the term “sipe” it is meant a recess formed in a portion of the tread band, having a width smaller than 2 mm, preferably smaller than or equal to 1.5 mm, at least over a major portion of its depth. In the present description a sipe may have, at the radially outer surface of the tread band, a width greater than or equal to 2 mm, because of the presence of bevels at the radially outer edges.

By “width” or “maximum width” of a sipe, unless otherwise specified, it is therefore meant the width (or maximum width) of the sipe measured when the tyre is new, at the aforementioned major portion of its depth (i.e., leaving out possible bevels at the radially outer surface of the tread band).

By “void-to-rubber ratio” it is meant the ratio between the total surface area of the recesses (sipes and/or grooves) of a given tread band portion (possibly of the whole tread band) and the total surface area of the given tread band portion (possibly of the whole tread band). For the purpose of evaluating the ratio, the determination of the overall surface area of the recesses is made considering the width as defined above (i.e., leaving out possible bevels at the radially outer surface of the tread band).

The present invention, in one or more preferred aspects thereof, may comprise one or more of the features hereafter presented.

Conveniently, at least some of the first sipes may extend over the whole width of the first rib.

Advantageously, the first transverse grooves may extend over the whole width of the first rib.

Advantageously, the first transverse grooves may have a width equal to or smaller than 7 mm.

Preferably, the first sipes have a substantially straight course forming with said equatorial plane an angle θ′ greater than the angle θ.

Preferably, the first sipes are substantially parallel to one another over at least 80% of their extension.

Conveniently, the central region may comprise a third and a fourth circumferential groove axially delimiting at least a second and a third circumferential rib.

Preferably, the second and/or third circumferential ribs may respectively comprise a plurality of pairs of second and/or third transverse grooves.

Preferably, the second and/or third transverse grooves of said pairs may extend over at most 40% of the width of the rib where they are located.

Conveniently, the second and/or third transverse grooves may extend from a circumferential groove adjacent to the rib where they are located.

Advantageously, the second and/or third transverse grooves of each pair may extend starting from two different circumferential grooves which are adjacent to the rib where they are located.

Preferably, the second and/or third transverse grooves may be counter-inclined relative to the first segment of the first transverse grooves.

Conveniently, in said pairs of second and/or third transverse grooves a second and/or a third transverse groove extends on the continuation of the remaining second and/or third circumferential groove.

Preferably, the second and/or third transverse grooves may have a substantially straight course.

Advantageously, the course of the second and/or third transverse grooves forms with the equatorial plane an angle α greater than or equal to 45°.

Preferably, the second and/or third grooves of a same pair may extend on the continuation of the second segment of the first transverse grooves.

Advantageously, the second and third transverse grooves may have a width equal to or smaller than 7 mm.

Advantageously, the second and third circumferential ribs may respectively comprise a plurality of second and/or third sipes having a substantially transverse course.

Conveniently, the second and/or third sipes may extend over at least 80% of the width of the rib where they are located.

Preferably, the second and/or third sipes may extend over the whole width of the rib where they are located.

Advantageously, the second and/or third sipes may have a substantially straight course.

Conveniently, the second and/or third sipes may be counter-inclined relative to the first segment of the first transverse grooves.

Advantageously, the second and/or third sipes may have a course substantially parallel to the course of the second and/or third transverse grooves.

Preferably, in the rib where they are located, the second and/or third sipes may be alternated with the pairs of second and/or third transverse grooves.

Conveniently, in the rib where they are located, at least some of said second and/or third sipes may be alternated with the pairs of second and/or third transverse grooves in a 2-to-1 ratio.

The Applicant further believes that, still in order to control the stiffness distribution on the tread band without reducing the draining ability of the same, the transverse grooves in the central region should have a significant in the rib where they are located, but preferably a variable width.

To this end, conveniently, the second and/or third transverse grooves of each pair may be connected by a fourth and/or a fifth sipe.

Advantageously, the fourth and/or fifth sipes may have a course parallel to the course of the second and/or third transverse grooves.

Preferably, the first, second, and third circumferential ribs may have a void-to-rubber ratio, resulting from said plurality of transverse grooves alone, equal to or smaller than 0.1.

Conveniently, the first, second, and third circumferential rib each have a void-to-rubber ratio, resulting from the plurality of transverse grooves and sipes, equal to or smaller than 0.16.

Preferably, the contribution of said plurality of sipes alone to the void-to-rubber ratio in each of said first, and/or second, and/or third circumferential ribs is smaller than or equal to 0.06.

Preferably, the first circumferential rib has a void-to rubber ratio equal to or greater than the void-to-rubber ratio of the second and/or third circumferential rib.

Conveniently, the first shoulder region and the second shoulder region respectively comprise a plurality of fourth and fifth transverse grooves having a maximum width greater than or equal to 4 mm and extend over at least 50% of the width of the shoulder region where they are located.

Preferably, the fourth or fifth transverse grooves may respectively extend from the first or the second circumferential groove.

Advantageously, the first shoulder region and the second shoulder region further comprise a plurality of sixth and seventh sipes having a substantially transverse course.

Preferably, in the first shoulder region the sixth sipes may be alternated in circumferential direction with the fourth transverse grooves at least in a 1-to-1 ratio. Preferably, in the second shoulder region the seventh sipes may be alternated in circumferential direction with the fifth transverse grooves at least in a 1-to-1 ratio.

Further features and advantages of the invention shall become clearer from the detailed description of some preferred, although not exclusive, embodiments of a high or ultra high performance car tyre, intended for use also on track, according to the present invention.

### BRIEF DESCRIPTION OF THE DRAWINGS

Such description shall be made hereafter with reference to the accompanying drawings, provided only for indicating, and thus non-limiting, purposes, wherein:

FIG. 1 shows a perspective view of an example of a tyre according to the invention;

FIG. 2 is an enlarged view of a cross section of the tyre of FIG. 1;

FIG. 3 is a schematic plan view of a tread band portion of the tyre of FIG. 1;

FIG. 4 is a schematic plan view of a tread band portion of a second example of a tyre according to the invention.

### DETAILED DESCRIPTION OF EMBODIMENTS OF THE INVENTION

With reference to the attached figures, a tyre for car wheels, in particular an “all season” tyre for wheels high or ultra high performance cars, is generally indicated at 100.

The structure of the tyre 100 is per se of conventional type and comprises a carcass, a tread band 7 placed in crown to the carcass, a pair of axially opposed sidewalls, ending in beads reinforced by bead cores and associated bead fillers. The tyre preferably also comprises a belt structure interposed between the carcass and the tread band. The carcass comprises one or more carcass plies anchored to the bead cores, whereas the belt structure comprises two radially superimposed belt strips. The belt strips are formed of pieces of a rubberized fabric incorporating metal cords parallel to one another in each strip and having a crossed orientation, preferably with a symmetrical inclination relative to the equatorial plane, relative to the cords of adjacent strips. Preferably, the belt structure also comprises, in a radially outer position, a third belt layer provided with cords oriented substantially parallel to the equatorial plane. Preferably, although not necessarily, the tyre according to the invention has a nominal section width of at least about 225, more preferably of at least about 245. For example, the tyre may have a nominal section width of 225, 245, 275, 295, 305, 315. Preferably, the tyre according to the invention has a reduced section height. For example, the section height may be smaller than or equal to 60%, more preferably smaller than or equal to 50%, of the nominal section width.

The tread band 7 has distribution of transverse grooves and sipes, described in more detail below, which are arranged so as to obtain a predetermined void-to-rubber ratio.

The tread band 7 has a reduced void-to-rubber ratio resulting from transverse grooves alone, so as to have an “all season” tyre, preferably a void-to-rubber ratio smaller than 0.30, more preferably smaller than 0.28.

Preferably, the void-to-rubber ratio of the tread band 7 resulting from transverse grooves alone is greater than 0.23, preferably greater than 0.24.

Instead, the void-to-rubber ratio of the tread band 7 resulting from transverse grooves and sipes is smaller than or equal to 0.33, preferably smaller than or equal to 0.30.

Preferably, the void-to-rubber ratio of the tread band 7 resulting from sipes alone is smaller than or equal to 0.06.

Preferably, although not necessarily, the tyre according to the invention is of the asymmetrical type, i.e., the tread band pattern of the tyre on the right of the equatorial plane X-X is substantially different from that on the left. Therefore, the tyre 100 and/or the tread band 7 has an inner side to be preferably arranged, when fitted, towards the inside of the vehicle (on the right in the example shown in the figures) and an outer side to be preferably arranged towards the outside of the vehicle (on the left in the example shown in the figures).

The tread band 7 is provided with at least two circumferential grooves, respectively a first 1 and a second 2 circumferential groove, extending in a substantially circumferential direction.

The first and second circumferential grooves 1 and 2 respectively separate a central region L1 of the tread band 7 from a first shoulder region L2 and from a second shoulder region L3, respectively located to the left and right of the central region L1. In the embodiments shown in the figures the first shoulder region L2 is located on the outer side of the tyre, whereas the second shoulder region L3 is located on the inner side of the tyre.

The central region L1 extends across the equatorial X-X plane of the tyre. The first L2 and second L3 shoulder regions extend close to the axial ends of the tread band 7.

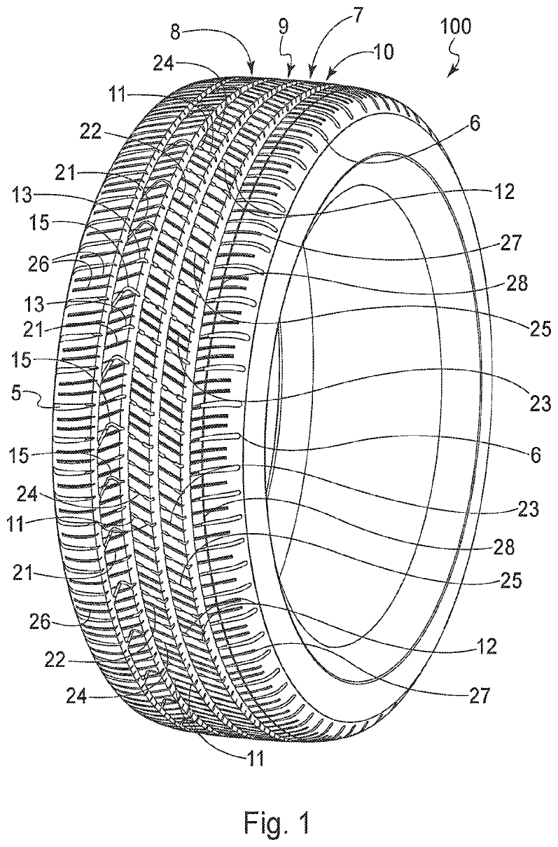

As exemplarily shown in the embodiments of FIGS. 1-4, the central region L1 takes up a substantial portion of the tread band 7.

In particular, the central region L1 may have a width greater than or equal to 35% of the effective width of the tread band 7, i.e., the width of the tread band portion intended to contact the ground; the first shoulder region L2 may have a width smaller than 35% of the effective width of the tread band 7; the second shoulder region L3 may have a width smaller than 30% of the effective width of the tread band 7.

Moreover, the central region L1 may have a width smaller than or equal to 60% of the effective width of the tread band 7, the first shoulder region L2 may have a width greater than 20% of the effective width of the tread band 7, and the second shoulder region L3 may have a width greater than 20% of the effective width of the tread band 7.

Preferably, the first shoulder rhnjegion L2 has a width substantially equal to the width of the second shoulder region L3.

The first circumferential groove 1 delimits the first shoulder region L2 from the central region L1 of the tread band 7 in axial direction, whereas the second circumferential groove 2 delimits the second shoulder region L3 from the central region L1 in axial direction.

Preferably, the first 1 and second 2 circumferential grooves have a substantially straight course in the circumferential direction, preferably over the whole circumferential development of the tyre.

The first circumferential groove 1 may have a different width as compared to the second circumferential groove 2.

In particular, as exemplarily shown in the embodiments of FIGS. 1-4, the first circumferential groove 1 may have a width smaller than the width of the second circumferential groove 2. For example, the first circumferential groove 1 may have a width smaller than 90% of the width of the second circumferential groove 2, preferably greater than 60% of the width of the second circumferential groove 2.

The first and second circumferential grooves 1 and 2, together with the third 3 and fourth 4 circumferential grooves described in more detail below, are mainly provided for draining water from the footprint area.

The first circumferential groove 1 may, for example, have a width smaller than or equal to about 12 mm, preferably smaller than or equal to about 11 mm, preferably greater than or equal to about 6 mm.

The second circumferential groove 2 may, for example, have a width smaller than or equal to about 15 mm, preferably greater than or equal to about 8 mm.

Preferably, the first and second circumferential grooves 1 and 2 may have a depth smaller than or equal to about 10 mm, more preferably smaller than or equal to about 9 mm, preferably greater than or equal to about 5 mm. Preferably, the first circumferential groove 1 has a depth substantially equal to the depth of the second circumferential groove 2.

In all embodiments shown in FIGS. 1-4, the tread band 1 further comprises, in the central region L1, a third 3 and a fourth 4 circumferential groove.

Preferably, the third 3 and the fourth 4 circumferential grooves have a substantially straight course in the circumferential direction, preferably over the whole circumferential development of the tyre.

Preferably, the third circumferential groove 3 has a width greater than the width of the first circumferential groove 1.

Preferably, the third circumferential groove 3 may have, for example, a width smaller than or equal to about 14 mm, preferably greater than or equal to about 8 mm.

The third circumferential groove 3 may have a depth smaller than or equal to about 10 mm, more preferably smaller than or equal to about 9 mm, preferably greater than or equal to about 5 mm.

Preferably, the fourth circumferential groove 4 has a width greater than the width of the first 1 and, more preferably, of the third circumferential groove 3.

Preferably, the fourth circumferential groove 4 may have a width smaller than or equal to about 15 mm, more preferably greater than or equal to about 8 mm.

The fourth circumferential groove 4 may have a depth smaller than or equal to about 10 mm, more preferably smaller than or equal to about 9 mm, preferably greater than or equal to about 5 mm.

Preferably, the width of the circumferential grooves increases when moving axially away from the first shoulder region L2 towards the second shoulder region L3.

Preferably, the first 1, second 2, third 3, and fourth 4 circumferential grooves have substantially the same depth.

Still referring to the embodiments shown in FIGS. 1-4, the first 1, second 2, third 3, and fourth 4 circumferential grooves are formed so as to have a straight section of a substantially trapezoidal shape.

The central L1 region is designed to maintain, as far as possible for an “all season” tyre, a high amount of rubber to the ground, and a distribution of grooves and sipes that keeps the stiffness of the tread band 7 as uniform as possible.

To this end, the central region L1 has a void-to-rubber ratio greater than about 0.24, preferably greater than about 0.26.

Preferably, the central region L1 has a void-to-rubber ratio lower than about 0.35.

In the embodiments shown in FIGS. 1-4, the third circumferential groove 3 and the fourth circumferential groove 4 define, together with the first 1 and the second 2 circumferential grooves, a first 8, a second 9 and a third 10 circumferential rib in the central region L1.

In the tyre shown in FIGS. 1-4, the first circumferential rib 8 is located between the first circumferential groove 1 and the third circumferential groove 3. The second circumferential rib 9 is located between the third circumferential groove 3 and the fourth circumferential groove 4, whereas the third circumferential rib 10 is located between the fourth circumferential groove 4 and the second circumferential groove 2.

Despite being an “all season” tyre, in order to increase the amount of “rubber to the ground” at the central region L1, thus optimising handling and rolling resistance, the central region L1 and particularly the circumferential ribs 8, 9, 10 are characterised by void-to-rubber ratios which are not high considering the contribution given by the transverse grooves located in this portion of the tread band 7 alone.

In particular, the circumferential ribs 8, 9, 10 are characterized by void-to-rubber ratios which are not high considering the contribution given respectively by the first 15, second 11, third 12, and possibly sixth 13 transverse grooves, described in more detail below, alone.

At least one of the first 8, second 9, and third 10 circumferential ribs, preferably all of them, have indeed a void-to-rubber ratio smaller than or equal to about 0.1, considering the contribution given respectively by the first 15, second 11, third 12, and possibly sixth 13 transverse grooves alone.

Preferably, the first 8, second 9, and third 10 circumferential ribs each have instead a void-to-rubber ratio equal to or smaller than 0.16 when considering the contribution respectively of the first 15, second 11, third 12, and possibly sixth 13 transverse grooves and the contribution respectively of the first 21, second 22, third 23, fourth 24, and fifth 25 sipes.

Preferably, the contribution to the void-to-rubber ratio in each of the first 8, second 9, and third 10 circumferential ribs given by the first 21 and/or second 22 and/or third 23 and/or fourth 24 and/or fifth 25 sipes alone is therefore smaller than or equal to 0.06.

Preferably, for this purpose, the first circumferential rib 8 has a plurality of first transverse grooves 15 alternated with a plurality of first transverse sipes 21 in circumferential direction.

Preferably, the first transverse grooves 15 extend over at least 90% of the width of the first circumferential rib 8.

Preferably, the first transverse grooves 15 extend over 100% of the width of the first circumferential rib 8, that is, the first transverse grooves 15 extend from the first circumferential rib 1 to the third circumferential rib 3.

The first transverse grooves 15 have at least one first segment 15′, at least one second segment 15″ counter-inclined relative to the first segment 15′, and at least one connecting third segment 15″′ located between the first segment 15′ and the second segment 15″.

The first segment 15′ and the second segment 15″ respectively have a straight course, whereas the third segment 15″′ has a curvilinear course.

The first segment 15′ extends from the first circumferential groove 1 up to reaching the third segment 15″′, whereas the second segment 15″ extends from the third circumferential groove 3.

Preferably, the first segment 15′ has an inclined course relative to a direction parallel to the equatorial plane X-X so as to form an angle θ smaller than or equal to 70°.

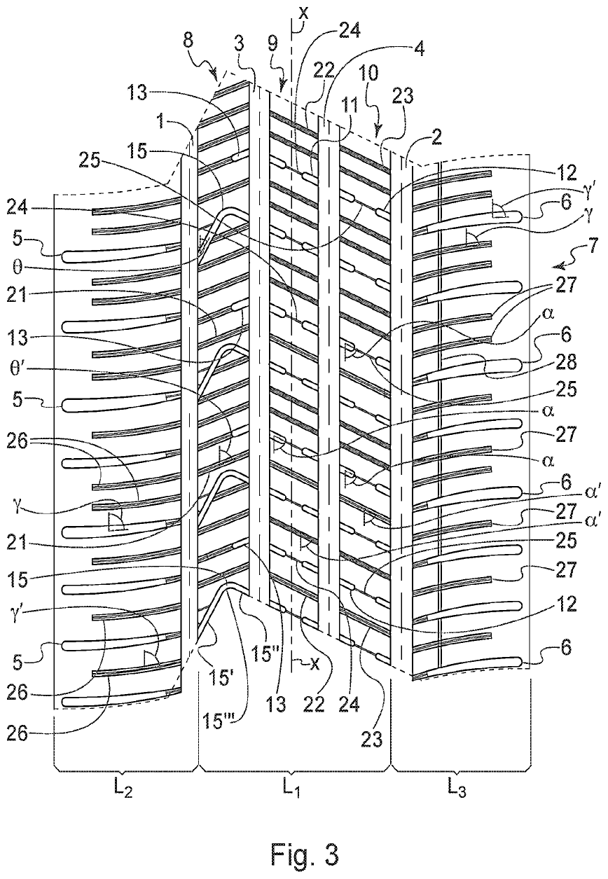

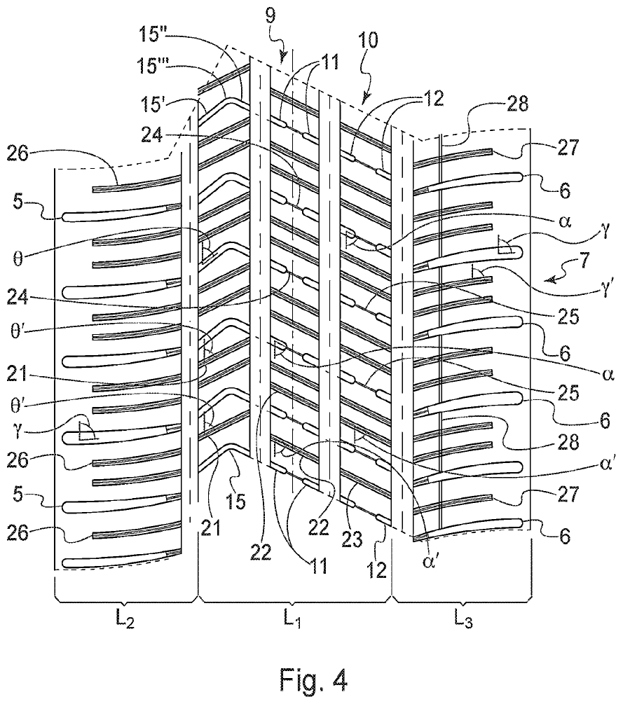

In the embodiment shown in FIG. 3, the first segment 15′ has an inclined course relative to a direction parallel to the equatorial plane X-X so as to form an angle θ smaller than or equal to 45°. In the embodiment shown in FIG. 4, the first segment 15′ has an inclined course relative to a direction parallel to the equatorial plane X-X so as to form an angle θ smaller than or equal to 60°.

Preferably, the second segment 15″, which is counter-inclined relative to the first segment 15′, has an inclined course relative to a direction parallel to the equatorial plane X-X so as to form an angle θ″ greater than or equal to 45°, preferably greater than or equal to 50°.

The first transverse grooves 15 have a maximum width greater than about 2 mm. Preferably, the first transverse grooves 15 have a maximum width smaller than about 7 mm. For example, they may have a maximum width of between about 2 and about 5 mm.

The first transverse grooves 15 may have, as in the examples shown in FIGS. 1-4, a substantially constant width along their extension.

The first transverse grooves 15 have a maximum depth smaller than or equal to about 9 mm, more preferably smaller than or equal to about 8 mm, in any case greater than or equal to about 5 mm.

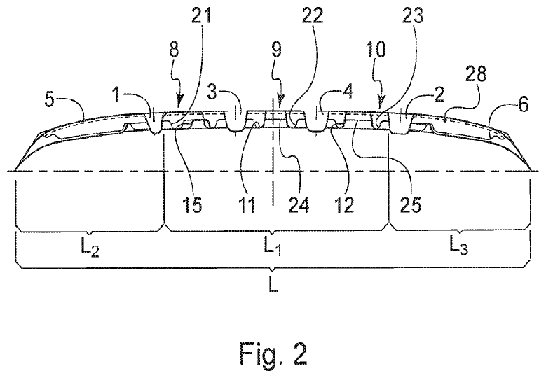

Preferably, the first transverse grooves 15 do not have a constant depth along their extension but, as best shown in FIG. 2, have a minimum depth at their central portion.

In order to improve behavior on snow, the first circumferential rib 8 has a plurality of first sipes 21.

In particular, the contribution to the void-to-rubber ratio in the first circumferential rib 8 given by the first sipes 21 is thus smaller than or equal to 0.06.

The first sipes 21 extend over at least 60% of the width of the first circumferential rib 8 where they are located.

In the embodiments shown in the figures, some first sipes 21 extend over 100% of the width of the first circumferential rib 8 where they are located.

In other words, said first sipes 21 extend on the first circumferential rib 8 from the first circumferential groove 1 to the third circumferential groove 3.

Preferably, the first sipes 21 have a straight course, substantially over their whole extension.

In the embodiments shown in the figures, the first sipes 21 have a substantially straight course, suitable for forming an angle θ′ with the equatorial plane X-X.

Preferably, the angle θ′ is concordant with the angle θ formed by the course of the first segment 15′ of the first transverse grooves 15 with the equatorial plane X-X. Preferably, the angle θ′ is greater than the angle θ formed by the course of the first segment 15′ of the first transverse grooves 15 with the equatorial plane X-X.

Preferably, the first sipes 21 all have substantially the same inclination. Preferably, the first sipes 21 are substantially parallel to each other over at least 80% of their extension.

In the embodiment shown in the figures, the first sipes 21 are substantially parallel to one another over 100% of their extension.

Preferably, the first sipes 21 do not have mutual intersection points.

Preferably, the first sipes 21 have a minimum distance from one another in circumferential direction greater than or equal to 6 mm.

In the embodiment shown in FIG. 4, the first sipes 21 do not have mutual intersection points even with the first transverse grooves 15, whereas in the embodiment shown in FIGS. 1 and 3, the first sipes 21 do have intersection points with the first transverse grooves 15.

In the first circumferential rib 8, the first sipes 21 are alternated in circumferential direction with the first transverse grooves 15.

Preferably, in the first circumferential rib 8, the first sipes 21 are alternated in circumferential direction with the first transverse grooves 15 at least in a 1-to-1 ratio.

In particular, in the embodiment shown in FIGS. 1 and 3, in the first circumferential rib 8 the first sipes 21 are alternated in circumferential direction with the first transverse grooves 15 at least in a 4-to-1 ratio.

In the embodiment shown instead in FIG. 4, in the first circumferential rib 8 the first sipes 21 are alternated in circumferential direction with the first transverse grooves 15 in a 1-to-1 or 2-to-1 ratio.

The first sipes 21 may have, as in the examples shown in FIGS. 3, 4, a substantially constant width along their extension.

The first sipes 21 have a maximum width of smaller than 2 mm. Preferably, the first sipes 21 have a maximum width of between 0.4 and 1.5 mm.

Preferably, the first sipes 21 do not have a constant depth along their extension but, as best shown in FIG. 2, have a maximum depth at their central portion and at least two respective depth reductions at their ends.

Preferably, the first sipes 21 have a maximum depth greater than about 5 mm.

Preferably, the first sipes 21 have a maximum depth smaller than about 9 mm.

Preferably, the maximum depth of the first sipes 21 is smaller than the maximum depth of the first and third circumferential grooves 1, 3.

In the embodiment of FIGS. 1-3, the first rib 8 further has sixth transverse grooves 13.

The sixth transverse grooves 13 may have an extension equal to at most 40% of the width of the first rib 8 where they are located.

Preferably, the sixth transverse grooves 13 may have an extension equal to at most 30% of the width of the first rib 8 where they are located.

In the embodiment shown in FIGS. 1-3, the sixth transverse grooves 13 extend on the continuation of a respective first sipe 21.

In particular, again with reference to the embodiment shown in FIGS. 1-3, the sixth transverse grooves 13 extend from one end of a respective first lamella 21 to the third circumferential groove 3.

In the embodiment shown in FIGS. 1-3, only some of the first slats 21 are joined to sixth grooves 13.

Preferably, the sixth transverse groove 13 have a width greater than about 2 mm.

Preferably, the sixth transverse grooves 13 have a width of smaller than about 7 mm.

For example, they may have a width of between about 2 and about 5 mm.

The sixth transverse grooves 13 have a maximum depth of smaller than or equal to about 9 mm, more preferably smaller than or equal to about 8 mm, preferably greater than or equal to about 5 mm.

Preferably, the sixth transverse grooves 13 have a constant depth along their extension.

In particular, the second rib 9 comprises a plurality of second transverse grooves 11, arranged in pairs along the circumferential development of the tyre, and a plurality of second transverse sipes 22.

Each of the second transverse grooves 11 of said pairs may have an extension equal to at most 40% of the width of the second rib 9 where they are located.

Preferably, each of the second transverse grooves 11 of said pairs may have an extension equal to at most 30% of the width of the second rib 9 where they are located.

The second transverse grooves 11 may extend from a circumferential groove adjacent to the second central rib 9 where they are located.

Advantageously, the second transverse grooves 11 of the same pair extend from two different circumferential grooves adjacent to the second central rib 9 where they are located.

In particular, in the embodiments shown in FIGS. 3 and 4, a second transverse groove 11 extends starting from the third circumferential groove 3, whereas the remaining second transverse groove 11 of the same pair extends starting from the fourth circumferential groove 4.

The second transverse grooves 11 preferably have a straight course.

Preferably, in a same pair of second transverse grooves 11, a second transverse groove 11 extends on the continuation of the remaining second transverse groove 11.

In the embodiments shown in the figures, the second transverse grooves 11 have an inclined course relative to a direction parallel to the equatorial plane X-X so as to form an angle α greater than or equal to 45°, preferably greater than or equal to 50°.

Preferably, the second transverse grooves 11 may be counter-inclined relative to the first segment 15′ of the first transverse grooves 15.

In the embodiments shown in the figures, the second transverse grooves of a same pair extend on the continuation of the second segment 15″ of the first transverse grooves 15.

Preferably, the second transverse grooves 11 have a width greater than about 2 mm.

Preferably, the second transverse grooves 11 have a width of smaller than about 7 mm.

For example, they may have a width of between about 2 and about 5 mm.

In the embodiments shown in FIGS. 3 and 4, the second transverse grooves 11 have a width substantially equal to the width of the first transverse grooves 15.

The second transverse grooves 11 may have a maximum depth smaller than or equal to about 9 mm, more preferably smaller than or equal to about 8 mm, preferably greater than or equal to about 5 mm. The second transverse grooves 11 may have a constant depth along the respective extension.

Conveniently, as shown for example in the embodiments of FIGS. 3 and 4, the second transverse grooves 11 of a same pair may be connected by a respective fourth sipe 24, described in more detail below.

In order to improve the behaviour on snow, the second circumferential rib 9 further has a plurality of second sipes 22 with a substantially transverse course.

Preferably, the second transverse sipes 22 extend over at least 80% of the width of the second circumferential rib 9.

Preferably, the second transverse sipes 22 extend over 100% of the width of the second circumferential rib 9.

In other words, referring to the embodiments shown in the figures, the second transverse sipes 22 extend starting from the third circumferential groove 3 up to the fourth circumferential groove 4.

Preferably, the second transverse sipes 22 have a straight course.

The second sipes 22 have an inclined course relative to a direction parallel to the equatorial plane X-X so as to form an angle α′ greater than or equal to 45°, preferably greater than or equal to 50°.

Preferably, the second sipes 22 are counter-inclined relative to the first segment 15′ of the first transverse grooves 15.

Preferably, the second sipes 22 do not have mutual intersection points and/or intersection points with the second transverse grooves 11.

Preferably, the second sipes 22 are substantially parallel to the second transverse grooves 11.

In the embodiment shown in the figures, the second sipes 22 are alternated in circumferential direction with the second transverse grooves 11 at least in a 1-to-1 ratio.

Preferably, at least some of the second sipes 22 are alternated in circumferential direction with the second transverse grooves 11 in a 2-to-1 ratio.

Preferably, the second sipes 22 have a width equal to or smaller than about 2 mm.

Preferably, they have a maximum width of between 0.4 and 1.5 mm.

The second sipes 22 may have, as in the examples shown in the figures, a substantially constant width along their extension.

Preferably, the second sipes 22 have a maximum depth greater than about 5 mm. The second sipes 22 have a maximum depth smaller than about 9 mm.

Preferably, the second sipes 22 do not have a constant depth along their extension but, as best shown in FIG. 2, have a maximum depth at their central portion and at least two respective depth reductions at their ends.

Preferably, the maximum depth of the second sipes 22 is smaller than the maximum depth of the third 3 and fourth 4 circumferential grooves.

As previously mentioned, the second central rib further has fourth sipes 24.

The fourth sipes 24 are arranged so as to connect two second transverse grooves 11 of a same pair.

The fourth sipes 24 are thus arranged on the continuation of the second transverse grooves 11 and extend starting from a second transverse groove 11 up to the remaining transverse groove 11 of the same pair.

The fourth sipes 24 are parallel to the second sipes 11.

The fourth sipes 24 have a width equal to or smaller than 2 mm.

For example, they may have a width of between about 0.4 and about 1.5 mm.

In the embodiments shown in FIGS. 3 and 4, the fourth sipes 24 have a substantially constant width along their extension.

Preferably, the fourth sipes 24 have a maximum depth greater than about 2 mm.

Preferably, the fourth sipes 24 have a maximum depth smaller than about 9 mm.

Preferably, the fourth sipes 24 have a constant depth along the respective extension.

The third rib 10 has substantially the same void-to-rubber ratio as the second central rib 9.

In particular, the third rib 10 comprises a plurality of third transverse grooves 12, arranged in pairs along the circumferential development of the tyre, and a plurality of third sipes 23.

Each of the third transverse grooves 12 of said pairs may have an extension equal to at most 40% of the width of the second rib 9 where they are located.

Preferably, each of the third transverse grooves 12 of said pairs may have an extension equal to at most 30% of the width of the third rib 10 where they are located.

The third transverse grooves 12 may extend starting from one of the circumferential grooves adjacent the third central rib 10.

Advantageously, the third transverse grooves 12 of a same pair extend starting from two different circumferential grooves adjacent to the third central rib 10 where they are located.

In particular, in the embodiments shown in FIGS. 3 and 4, a third transverse groove 12 extends from the fourth circumferential groove 4, whereas the remaining third transverse groove 12 of the same pair extends from the second circumferential groove 2.

The third transverse grooves 12 preferably have a straight course.

Preferably, in the pairs of third transverse grooves 12, a third transverse groove 12 extends on the continuation of the remaining third transverse groove 12.

In the embodiments shown in FIGS. 3 and 4, the third transverse grooves 12 have an inclined course relative to a direction parallel to the equatorial plane X-X so as to form an angle α greater than or equal to 45°, preferably greater than or equal to 50°.

Preferably, the third transverse grooves 12 are counter-inclined relative to the first segment 15′ of the first transverse grooves 15.

In the embodiments shown in FIGS. 3 and 4, the third transverse grooves 12 of a same pair extend on the continuation of the second transverse grooves 11.

Preferably, the third transverse grooves 12 have a width greater than about 2 mm.

Preferably, the third transverse grooves 12 have a width smaller than about 7 mm. For example, they may have a width of between about 2 and about 5 mm.

In the embodiments shown in FIGS. 3 and 4, the third transverse grooves 12 have a width substantially equal to the width of the second transverse grooves 11.

The third transverse grooves 12 have a maximum depth smaller than or equal to about 9 mm, more preferably smaller than or equal to about 8 mm, preferably greater than or equal to about 5 mm. The third transverse grooves 12 may have a constant depth along the respective extension.

Conveniently, as shown for example in the embodiments of FIGS. 3 and 4, the third transverse grooves 12 of a same pair may be connected by a respective fifth sipe 25, described in more detail below.

In order to improve the behaviour on snow, the third circumferential rib 10 further has a plurality of third sipes 23 having a substantially transverse course. In particular, the contribution to the void-to rubber ratio in the third circumferential rib 10 provided by the third 23 and fifth 25 sipes is smaller than or equal to 0.06.

Preferably, the third transverse sipes 23 extend over at least 80% of the width of the third circumferential rib 10.

Preferably, the third transverse sipes 23 extend over 100% of the width of the third circumferential rib 10.

In other words, referring to the embodiments shown in the figures, the third sipes 23 extend starting from the fourth circumferential groove 4 up to the second circumferential groove 2.

Preferably, the third sipes 23 have a straight course.

The third sipes 23 have an inclined course relative to a direction parallel to the equatorial plane X-X so as to form an angle α′ greater than or equal to 45°, preferably greater than or equal to 50°.

Preferably, the third sipes 23 are counter-inclined relative to the first segment 15′ of the first transverse grooves 15.

Preferably, the third sipes 23 do not have mutual intersection points and/or intersection points with the third transverse grooves 12.

Preferably, the third sipes 23 are substantially parallel to the third transverse grooves 12.

Preferably, the third sipes 23 extend on the continuation of the second sipes 22.

In the embodiment shown in the figures, the third sipes 23 are alternated in circumferential direction with the third transverse grooves 12 at least in a 1-to-1 ratio.

Preferably, at least some of the third sipes 23 are alternated in circumferential direction with the third transverse grooves 12 in a 2-to-1 ratio. Preferably, the third sipes 23 have a width equal to or smaller than about 2 mm.

Preferably, they may have a width of between about 0.4 and 1.5 mm.

The third sipes 23 may have, as in the examples shown in the figures, a substantially constant width along their extension.

Preferably, the third sipes 23 have a maximum depth greater than about 5 mm. The third sipes 23 have a maximum depth smaller than about 9 mm.

Preferably, the third sipes 23 do not have a constant depth along their extension but, as best shown in FIG. 2, have a maximum depth at their central portion and at least two respective depth reductions at their ends.

The fifth sipes 25 are arranged so as to connect two third transverse grooves 12 of the same pair.

The fifth sipes 25 are thus disposed on the continuation of the third transverse grooves 12 and extend from a third transverse groove 12 to the remaining third transverse groove 12 of the same pair.

The fifth sipes 25 are parallel to the third sipes 12.

The fifth sipes 25 have a width equal to or smaller than about 2 mm.

For example, they may have a width of between about 0.4 and about 1.5 mm.

In the embodiments shown in FIGS. 3 and 4, the fifth sipes 25 have a substantially constant width along their extension.

Preferably, the fifth sipes 25 have a maximum depth greater than about 2 mm.

Preferably, the fifth sipes 25 have a maximum depth smaller than about 9 mm.

Preferably, the fifth sipes 25 have a constant depth along the respective extension.

The first and second circumferential grooves 1 and 2 identify on the tread band 1 the first shoulder region L2 and the second shoulder region L3, respectively located to the left and right of the central region L1.

Preferably, the first shoulder region L2 and/or the second shoulder region L3 have a void-to-rubber ratio provided by grooves and sipes smaller than or equal to about 0.35, preferably smaller than or equal to about 0.32. Preferably, the first shoulder region L2 and/or the second shoulder region L3 have a void-to-rubber ratio greater than or equal to about 0.20, preferably greater than or equal to about 0.22.

In particular, the first shoulder region L2 comprises a plurality of fourth transverse grooves 5 and a plurality of sixth sipes 26.

The fourth transverse grooves 5 have a substantially transverse course or a course slightly inclined relative to the axial direction.

In particular, the course of the fourth transverse grooves 5 forms with the equatorial plane X-X an angle γ of between 750 and 900 in absolute value.

Preferably, the fourth transverse grooves 5 have a maximum width greater than or equal to about 4 mm. Preferably, the fourth transverse grooves 5 have a maximum width smaller than or equal to about 8 mm, preferably smaller than or equal to about 7 mm.

The fourth transverse grooves 5 may have, as in the examples shown in FIGS. 1-4, a substantially increasing width moving away from the equatorial plane X-X.

The fourth transverse grooves 5 may have a depth that is not constant along the respective extension, for example a depth that decreases, preferably gradually, moving towards the axially outer edges of the tyre.

Each fourth transverse groove 5 preferably has a maximum depth of at least about 3 mm and smaller than about 8 mm.

The fourth transverse grooves 5 preferably have a first end located substantially at the first circumferential groove 1, and extend from said end in a substantially axial direction over at least 50% of the width of the first shoulder region L2.

In the embodiments shown in the figures, the fourth transverse grooves 5 of the first shoulder region L2 may have an extension equal to at least 70% of the width of the first shoulder region L2.

Preferably, the fourth transverse grooves 5 of the first shoulder region L2 may have an extension equal to at least 80% of the width of the first shoulder region L2, but in any case, equal to or smaller than 90% of the width of the first shoulder region L2.

Moreover, the first shoulder region L2 has a plurality of sixth sipes 26 with a substantially transverse course which also extend starting from the first circumferential groove 1.

The sixth sipes 26 have a substantially transverse course or a course slightly inclined relative to the axial direction.

In particular, the course of the sixth sipes 26 forms with the equatorial plane X-X an angle γ′ of between 75° and 90° in absolute value

The sixth sipes 26 may have an extension equal to 50% of the width of the first shoulder region L2.

Preferably, the sixth sipes 26 have a course parallel to the course of the fourth transverse grooves 5 over at least 50% of their extension, preferably over at least 80% of their extension, even more preferably over their whole extension.

The sixth sipes 26 may have, as in the examples shown in the figures, a substantially constant width along their extension.

The sixth sipes 26 have a width smaller than or equal to about 2 mm.

Preferably, the sixth sipes 26 may have a width of between 0.4 and 1.5 mm.

The sixth sipes 26 may have a maximum depth smaller than 9 mm.

The sixth sipes 26 may have a maximum depth greater than or equal to about 4 mm.

In the embodiment shown in the figures, the sixth sipes 26 are alternated in circumferential direction with the fourth transverse grooves 5 at least in a 1-to-1 ratio.

Preferably, the sixth sipes 26 are alternated in circumferential direction with the fourth transverse grooves 5 at least in a 2-to-1 ratio.

In the embodiments shown in the figures, the sixth sipes 26 are alternated in circumferential direction with the fourth transverse grooves 5 in a variable ratio.

In other words, in the circumferential direction some of the sixth sipes 26 are alternated with the fourth transverse grooves 5 in a 1-to-1 ratio, whereas others, namely the majority, are alternated with the fourth transverse grooves 5 in a 2-to-1 ratio.

In particular, the second shoulder region L3 comprises a plurality of fifth transverse grooves 6, a plurality of seventh sipes 27, and a circumferential sipes 28.

The second shoulder region L3 thus comprises at least fifth transverse grooves 6 and seventh sipes 27 repeating circumferentially.

Preferably, the fifth transverse grooves 6 have a straight course.

The fifth transverse grooves 6 have a substantially transverse course or a course slightly inclined with respect to the axial direction.

In particular, the course of the fifth transverse grooves 6 forms with the equatorial plane X-X an angle γ of between 750 and 900 in absolute value.

The fifth transverse grooves 6 preferably have a maximum width greater than or equal to about 4 mm. Preferably, the fifth transverse grooves 6 have a maximum width smaller than or equal to about 8 mm, preferably smaller than or equal to about 7 mm.

The fifth transverse grooves 6 may have, as in the examples shown in FIGS. 1-4, a substantially increasing width as they move away from the equatorial plane X-X.

The fifth transverse grooves 6 may have a depth that is not constant over the respective extension, for example a depth that decreases, preferably gradually, moving towards the axially outer edges of the tyre.

Each fifth transverse groove 6 preferably has a maximum depth of at least about 3 mm and smaller than about 8 mm.

The fifth transverse grooves 6 preferably have a first end located substantially at the second circumferential groove 2, and extend starting from said end in a substantially axial direction over at least 50% of the width of the second shoulder region L3.

In the embodiments shown in the figures, the fifth transverse grooves 6 of the second shoulder region L3 may have an extension equal to at least 70% of the width of the second shoulder region L3.

Preferably, the fifth transverse grooves 6 of the second shoulder region L3 may have an extension equal to at least 80% of the width of the second shoulder region L3, but, in any case, equal to or smaller than 90% of the width of the second shoulder region L3.

The number of fourth transverse grooves 5 of the first shoulder region L2 is substantially the same as the number of fifth transverse grooves 6 of the second shoulder region L3.

Preferably, the fifth transverse grooves 6 of the second shoulder region L3 are circumferentially staggered relative tothe fourth transverse grooves 5 of the first shoulder region L2.

The second shoulder region L3, as shown in the embodiments shown in the Figures, has a plurality of seventh sipes 27 with a substantially transverse course, that also extend from the second circumferential groove 2.

The seventh sipes 27 have a substantially transverse course or a course slightly inclined relative to the axial direction.

In particular, the course of the seventh sipes 27 forms with the equatorial plane X-X an angle γ′ of between 75° and 90° in absolute value

The seventh sipes 27 may have an extension equal to 50% of the width of the second shoulder region L3.

The seventh sipes 27 are parallel to one other and parallel to the fifth transverse grooves 6.

Preferably, the seventh sipes 27 have a course parallel to the course of the fifth transverse grooves 6 over at least 50% of their extension, preferably over at least 80% of their extension, even more preferably over their whole extension.

The seventh sipes 27 may have, as in the examples shown in the figures, a substantially constant width along their extension.

The seventh sipes 27 have a maximum width smaller than 2 mm.

Preferably, the seventh sipes 27 may have a maximum width of between 0.4 and 1.5 mm.

The seventh sipes 27 may have a maximum depth greater than or equal to about 4 mm.

In the embodiment shown in the figures, the seventh sipes 27 are alternated in circumferential direction with the fifth transverse grooves 6, at least in a 1-to-1 ratio.

Preferably, the seventh sipes 27 are alternated in circumferential direction with the fifth transverse grooves 6 at least in a 2-to-1 ratio.

In the embodiments shown in the figures, the seventh sipes 27 are alternated in circumferential direction with the fifth transverse grooves 6 in a variable ratio.

In other words, in the circumferential direction some of the seventh sipes 27 are alternated with the fifth transverse grooves 6 in a 1-to-1 ratio, whereas others, namely the majority, are alternated with the fifth transverse grooves 6 in a 2-to-1 ratio. In the embodiment shown in the figures, the second shoulder region is further provided with a circumferential sipe 28 extending substantially over the whole circumferential development of the tyre.

The circumferential sipe 28 has a substantially straight course in the circumferential direction, preferably over the whole circumferential development of the tyre.

The circumferential sipe 28 may have, for example, a width smaller than or equal to about 2 mm, in any case greater than or equal to about 1 mm.

The circumferential sipe 28 may have, for example, a constant width substantially over the whole circumferential development of the tyre.

Preferably, the circumferential sipe 28 may have a depth smaller than or equal to about 5 mm, preferably smaller than or equal to 3 mm, in any case greater than or equal to about 1 mm.

The sipes on the tread band 7 may have at least one radially outer edge, i.e., the edge connecting the substantially radial wall of the sipe and the respectively adjacent radially outer surface of the tread band 7, beveled.

In the embodiments shown in the figures, the first 21, second 22, third 23, sixth 26 and seventh 27 sipes have both radially outer edges beveled.

In a straight section, the bevels may be straight or curved and may affect the sipe over a depth of at most 1.5 mm, preferably 1 mm.

In the embodiments shown in the figures, the bevels are straight and their course forms with the substantially radial wall of the sipe an angle of about 45°.

Various modifications may be made to the embodiments described herein in detail, while remaining within the scope of protection of the invention, as defined by the following claims.

1-31. (canceled)

32. A car tyre having a tread band comprising a central region, extending across an equatorial plane (X-X), and two shoulder regions, which are separated from the central region by a first circumferential groove, axially delimiting a first shoulder region from the central region, and a second circumferential groove, axially delimiting a second shoulder region from the central region;
the central region having a width greater than or equal to at least 35% of an effective width of the tread band;
the central region having a plurality of ribs comprising respective pluralities of transverse grooves and sipes; wherein the plurality of ribs comprising at least one first rib comprising a plurality of first transverse grooves;
the first transverse grooves extending over at least 90% of the width of the first rib;
each first transverse groove comprising a substantially straight first segment, inclined relative to a direction parallel to the equatorial plane (X-X) to form an angle θ smaller than or equal to 70°, a substantially straight second segment, counter-inclined relative to the first segment, and a curvilinear connecting segment extending between the first segment and the second segment; and
the tread band further comprising a plurality of sipes comprising a plurality of first sipes located in the first rib between the first transverse grooves; wherein:
the first sipes extending over at least 60% of the width of the first rib;
the first sipes having a substantially straight course forming with the equatorial plane (X-X) an angle θ′ concordant with the angle θ; and
the first sipes having no mutual intersection points.

33. The tyre according to claim 32, wherein one or more of the first sipes extend over the whole width of the first rib.

34. The tyre according to claim 32, characterized in that the first transverse grooves extend over the whole width of the first rib.

35. The tyre according to claim 32, wherein the first sipes have a substantially straight course forming with the equatorial plane (X-X) an angle θ′ greater than the angle θ.

36. The tyre according to claim 32, wherein the first sipes are substantially parallel to one another over at least 80% of their extension.

37. The tyre according to claim 32, wherein the central region comprises a third, a fourth, or a third and fourth circumferential groove axially delimiting at least a second, a third, or a second and a third circumferential rib, wherein the second, third, or the second and the third circumferential ribs respectively comprising a plurality of pairs of second, third, or second and third transverse grooves.

38. The tyre according to claim 37, wherein the second, third, or second and the third transverse grooves of the pairs of second, third, or second and third transverse grooves extend over at most 40% of the width of the rib where the transverse grooves are located.

39. The tyre according to claim 37, wherein the second, third, or second and third transverse grooves extend from a circumferential groove which is adjacent to the rib where transverse grooves are located.

40. The tyre according to claim 37, wherein the second, third, second and third transverse grooves of each pair extend starting from two different circumferential grooves which are adjacent to the rib where the transverse grooves are located.

41. The tyre according to claim 37, wherein the second, third, or second and third transverse grooves are counter-inclined relative to the first segment of the first transverse grooves.

42. The tyre according to claim 37, wherein in the pairs of second, third, second and third transverse grooves, a second, a third, or a second and a third transverse groove extends on the prolongation of the remaining second, third, or second and third circumferential groove.

43. The tyre according to claim 37, wherein the second, third, or second and third transverse grooves have a substantially straight course.

44. The tyre according to claim 37, wherein the course of the second, third, or second and third transverse grooves forms with the equatorial plane (X-X) an angle α greater than or equal to 45°.

45. The tyre according to claim 37, wherein the second, third, or second and third circumferential ribs respectively comprise a plurality of second, third, or second and third sipes having a substantially transverse course.

46. The tyre according to claim 45, wherein the second, third, or second and third sipes extend over at least 80% of the width of the rib where the sipes are located.

47. The tyre according to claim 46, wherein the second, third, or second and third sipes extend over the whole width of the rib where the sipes are located.

48. The tyre according to claim 45, wherein the second, third, or second and third sipes have a substantially straight course.

49. The tyre according to claim 45, wherein the second, third, or second and third sipes are counter-inclined relative to the first segment of the first transverse grooves.

50. The tyre according to claim 45, wherein the second, third, or second and third sipes respectively have a course substantially parallel to the course of the second, third, or second and third transverse grooves.

51. The tyre according to claim 45, wherein, in the rib where the second, third, or second and third sipes are located, the second, third, or second and third sipes are alternated with the pairs of second, third, or second and third transverse grooves.

52. The tyre according to claim 45, wherein, in the rib where the second, third, and second and third sipes are located, one or more of the second, third, or second and third sipes are alternated with the pairs of second, third, or second and third transverse grooves in a 2-to-1 ratio.

53. The tyre according to claim 45, wherein the second, third, or second and third transverse grooves of each pair are connected by a fourth, a fifth, or a fourth and a fifth sipe.

54. The tyre according to claim 53, wherein the fourth, fifth, or fourth and fifth sipes have a course substantially parallel to the course of the second, third, or second and third transverse grooves, of the second, third, or second and third sipes, or of the second, third, or second and third transverse grooves, and of the second, third, or second and third sipes.

55. The tyre according to claim 47, wherein the second, third, or second and third transverse grooves of each pair lie on the continuation of the second segment of the first transverse grooves.

56. The tyre according to claim 47, wherein the first, the second, and the third circumferential rib have a void-to-rubber ratio resulting from the plurality of transverse grooves alone equal to or smaller than 0.1.

57. The tyre according to claim 56, wherein the first, the second, and the third circumferential rib each have a void-to-rubber ratio resulting from the plurality of transverse grooves and sipes equal to or smaller than 0.16.

58. The tyre according to claim 56, wherein the contribution of the plurality of sipes alone to the void-to-rubber ratio in each of the first, second, third, or any combination thereof circumferential ribs is smaller than or equal to 0.06.

59. The tyre according to claim 32, wherein the first shoulder region and the second shoulder region respectively comprise a plurality of fourth and fifth transverse grooves having a maximum width greater than or equal to 4 mm and extend over at least 50% of the width of the shoulder region where the transverse grooves are located.

60. The tyre according to claim 59, wherein the fourth or fifth transverse grooves respectively extend from the first or the second circumferential groove.

61. The tyre according to claim 59, wherein the first shoulder region and the second shoulder region respectively comprise a plurality of sixth and seventh sipes having a substantially transverse course.

62. The tyre according to claim 61, wherein in the first and second shoulder regions, the sixth and seventh sipes are alternated in circumferential direction with the fourth and fifth transverse grooves at least in a 1-to-1 ratio.
